(19) United States
(12) Patent Application Publication
(10) Pub. No.: US 2025/0344854 A1
(43) Pub. Date: Nov. 13, 2025

(54) RACK RECEIVER BRACKET ASSEMBLY

(71) Applicant: DriFlower, LLC, Ashland, OR (US)

(72) Inventor: Todd Chandler Larkins, Ashland, OR (US)

(21) Appl. No.: 19/203,966

(22) Filed: May 9, 2025

Related U.S. Application Data
(60) Provisional application No. 63/644,656, filed on May 9, 2024.

(51) Int. Cl. A47B 96/06; A01F 25/12; A47B 57/40

(52) U.S. Cl. CPC A47B 96/068; A01F 25/12; A47B 57/40

(57) ABSTRACT

A rack receiver bracket assembly includes an upper bracket, a bracket hook a rack receiver bracket, and an elongated post, and. The upper support bracket is configured to be secured to a support. The bracket hook includes a pair of hook points configured to secure the bracket hook to the upper bracket. The rack receiver bracket includes a connection tab and a rack receiver The elongated post is configured to support the bracket hook. The elongated post includes a plurality of latch holes on a face thereof configured for receipt of a connection tab of a rack receiver bracket. The rack receiver assembly can be used for hanging various objects, including vegetation for drying.

### CROSS-REFERENCE TO RELATED APPLICATION

This application claims the benefit of, and priority to, U.S. Provisional Patent Application No. 63/644,656, filed on May 9, 2024, the entire contents of which are hereby incorporated herein by reference in their entirety.

### TECHNICAL FIELD

This disclosure relates generally to a bracket assembly and more particularly, to a rack receiver bracket assembly for facilitating hang harvesting, transportation, drying, and unloading of vegetation.

### BACKGROUND

Vegetation, such as plants, herbs, flowers, hemp and/or cannabis, and other vegetation, are harvested, and then subsequently dried to produce a final product. In the field of growing cannabis specifically, the drying of cannabis and hemp has become an essential part of the processing of cannabis and hemp. Typically, the drying process requires the hemp and/or cannabis to be hung with plastic netting and requires manual labor.

The plastic netting process requires the hemp and/or cannabis to be hung one branch at a time and threaded through the netting to secure the hemp and/or cannabis. Removal of the hemp and/or cannabis requires careful unthreading of the hemp and/or cannabis from the plastic netting. Additionally, from harvest to drying there are multiple contacts with the hemp and/or cannabis that diminish the quality of the finished dried product.

### SUMMARY

An aspect of the present disclosure provides a rack receiver bracket assembly including an upper bracket, a bracket hook, a rack receiver bracket, and an elongated post. The upper bracket is configured to be secured to a support. The bracket hook includes a pair of hook points configured to secure the bracket hook to the upper bracket. The rack receiver bracket includes a connection tab and a rack receiver The elongated post is configured to support the bracket hook and includes a plurality of latch holes on a face thereof configured for receipt of the connection tab of a keyhole bracket.

In an aspect of the present disclosure, the upper bracket may further include a pair of elongated apertures positioned on a face of the upper bracket configured for receipt of the pair of hook points of the bracket hook.

In another aspect of the present disclosure, the upper bracket may be configured to be secured to the support via a top face of the upper bracket.

In an aspect of the present disclosure, the upper bracket may be configured to be secured to the support via a side face of the upper bracket.

In an aspect of the present disclosure, the rack receiver bracket may define a rectangular-shaped opening for receiving an elongated rack.

In an aspect of the present disclosure, the connection tab may be configured to insert into a latch hole of a plurality of latch holes of the elongated post to secure the rack receiver bracket at a fixed vertical position along the elongated post.

In an aspect of the present disclosure, the rack receiver bracket further may include at least two prongs configured to be positioned on opposite side faces of the elongated post.

Another aspect of the present disclosure provides a system for facilitating hang harvesting. The rack receiver bracket assembly includes an upper bracket, a bracket hook, a rack receiver bracket, an elongated post, and an elongated rack. The upper bracket is configured to be secured to a support. The bracket hook includes a pair of hook points configured to secure the bracket hook to the upper bracket. The rack receiver bracket includes a connection tab, a rack receiving cradle, and first and second prongs. The elongated post has first and second sides and/or a plurality of latch holes. The connection tab of the rack receiver bracket is secured within one latch hole of the plurality of latch holes to secure the rack receiver bracket at a fixed vertical position along the elongated post with the first and second prongs positioned on the first and second sides, respectively, of the elongated post. The elongated rack is secured within the rack receiving cradle of the rack receiver bracket.

In an aspect of the present disclosure, the upper bracket may further include a pair of elongated apertures positioned on a front face of the upper bracket configured for receipt of the pair of hook points of the bracket hook.

In an aspect of the present disclosure, the upper bracket may be configured to be secured to the support via a top face of the upper bracket.

In an aspect of the present disclosure, the upper bracket may be configured to be secured to the support via a side face of the upper bracket.

In an aspect of the present disclosure, the elongated post may be adjustable.

In an aspect of the present disclosure, the elongated rack may be configured to support a plurality of hangers.

In an aspect of the present disclosure, each hanger of the plurality of hangers may be configured to support vegetation.

Another aspect of the present disclosure provides a method for constructing a rack receiver bracket assembly. The method for constructing a rack receiver bracket assembly includes: connecting a bracket hook to an upper support bracket. The bracket hook is connected to an elongated post including a plurality of latch holes on a face thereof; adjusting the elongated post to a length spanning a distance between upper support bracket and ground; inserting a connection tab of a rack receiver bracket into a selected latch hole of the plurality of latch holes on the elongated post; positioning an elongated rack on the rack receiver bracket; and positioning a hanger on the elongated rack at a point on the elongated rack where the hanger locks in place. The hanger is configured to support vegetation.

In an aspect of the present disclosure, the method for constructing a rack receiver bracket assembly may include horizontally inserting the connection tab of the rack receiver bracket into the selected latch hole on the elongated post and turning the rack receiver bracket to a vertical position to lock the rack receiver bracket into place.

In another aspect of the present disclosure, the upper bracket may be configured to be secured to the support from a point below the support.

In an aspect of the present disclosure, the upper bracket may be configured to be secured to the support from a point adjacent to the support.

In another aspect of the present disclosure, the upper bracket may be configured to be secured to the support from a top portion of the support.

In an aspect of the present disclosure, the bracket hook may be connected to the elongated post including a plurality of latch holes on a face thereof.

In an aspect of the present disclosure, the elongated post may extend a vertical distance between the upper support bracket and the ground.

Further details and aspects of the present disclosure are described in more detail below with reference to the appended drawings.

### BRIEF DESCRIPTION OF DRAWINGS

A better understanding of the features and advantages of the present disclosure will be obtained by reference to the following detailed description that sets forth illustrative aspects, in which the principles of the present disclosure are utilized, and the accompanying drawings of which:

FIG. 1A illustrates an upper support bracket, in accordance with aspects of the present disclosure;

FIG. 1B illustrates a profile view of the upper support bracket of FIG. 1A, in accordance with aspects of the present disclosure;

FIG. 1C illustrates a frontal view of the upper support bracket of FIG. 1A, in accordance with aspects of the present disclosure;

FIG. 1D illustrates a top view of the upper support bracket of FIG. 1A, in accordance with aspects of the present disclosure;

FIG. 2A illustrates a side view of an elongated post connected to a bracket hook further connected to an upper support bracket, in accordance with aspects of the present disclosure;

FIG. 2B illustrates a profile view of the elongated post, bracket hook, and upper support bracket of FIG. 2A, in accordance with aspects of the present disclosure;

FIG. 2C illustrates a back view of the elongated post, bracket hook, and upper support bracket of FIG. 2A, in accordance with aspects of the present disclosure;

FIG. 2D illustrates a top view of the elongated post, bracket hook, and upper support bracket of FIG. 2A, in accordance with aspects of the present disclosure;

FIG. 3 illustrates a side view of a bracket hook, in accordance with aspects of the present disclosure;

FIG. 4A illustrates a side view of a rack receiver bracket, in accordance with aspects of the present disclosure;

FIG. 4B illustrates a side view of the rack receiver bracket of FIG. 4A, in accordance with aspects of the present disclosure;

FIG. 4C illustrates a top view of the rack receiver bracket of FIG. 4A, in accordance with aspects of the present disclosure;

FIG. 5 illustrates a front view of an elongated rack configured to receive a hanger, in accordance with aspects of the present disclosure;

FIG. 6A illustrates a side view of a rack receiver bracket connected to an elongated post, in accordance with aspects of the present disclosure;

FIG. 6B illustrates a back view of the rack receiver bracket and elongated post of FIG. 6A, in accordance with aspects of the present disclosure;

FIG. 7 illustrates an exemplary rack system utilizing rack receiver bracket assemblies, in accordance with aspects of the present disclosure; and

FIG. 8 illustrates an exemplary vegetation hanging system, in accordance with aspects of the present disclosure.

### DETAILED DESCRIPTION

The present disclosure relates generally to the field of rack receiver bracket assemblies for facilitating hang harvesting.

Aspects of the present disclosure are described in detail with reference to the drawings wherein like reference numerals identify similar or identical elements.

Although the present disclosure will be described in terms of specific aspects and examples, it will be readily apparent to those skilled in this art that various modifications, rearrangements, and substitutions may be made without departing from the spirit of the present disclosure. The scope of the present disclosure is defined by the claims appended hereto.

For the purpose of promoting an understanding of the principles of the present disclosure, reference will now be made to exemplary aspects illustrated in the drawings, and specific language will be used to describe the same. It will nevertheless be understood that no limitation of the scope of the present disclosure is thereby intended. Any alterations and further modifications of the novel features illustrated herein, and any additional applications of the principles of the present disclosure as illustrated herein, which would occur to one skilled in the relevant art and having possession of this disclosure, are to be considered within the scope of the present disclosure.

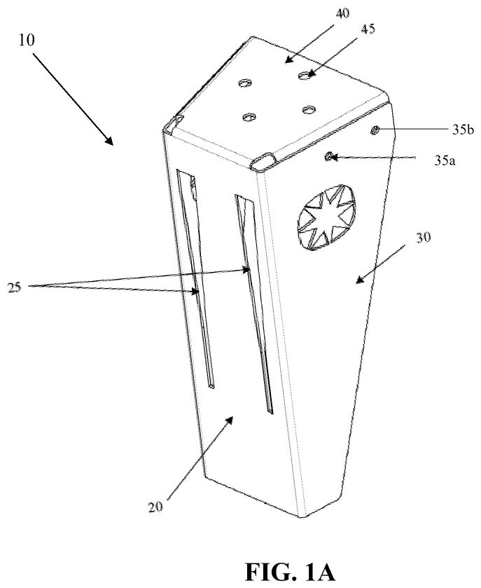

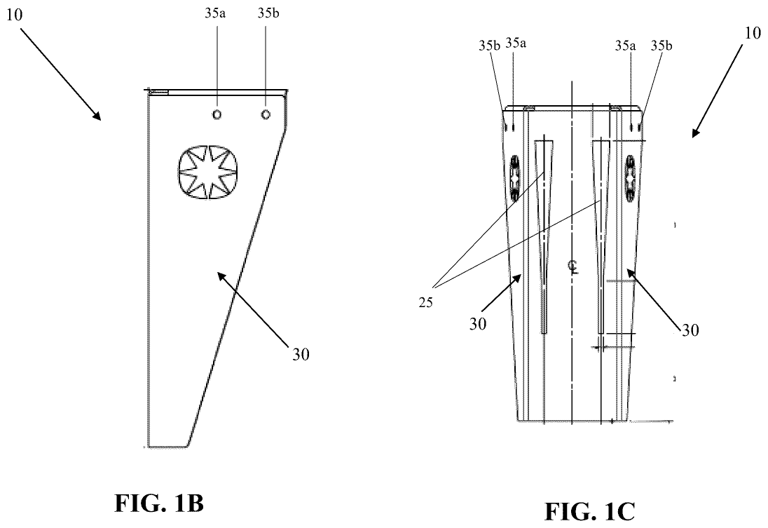

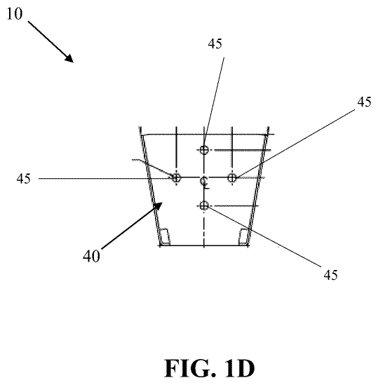

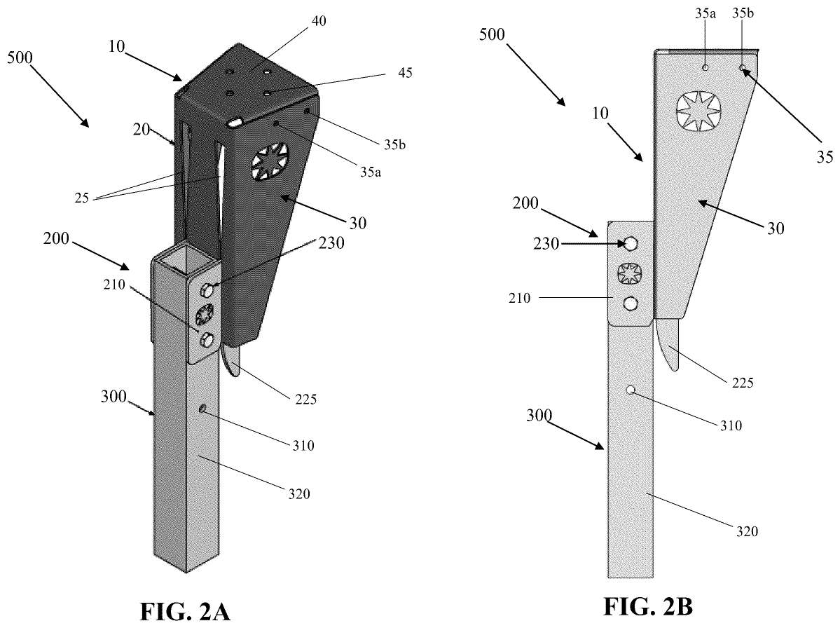

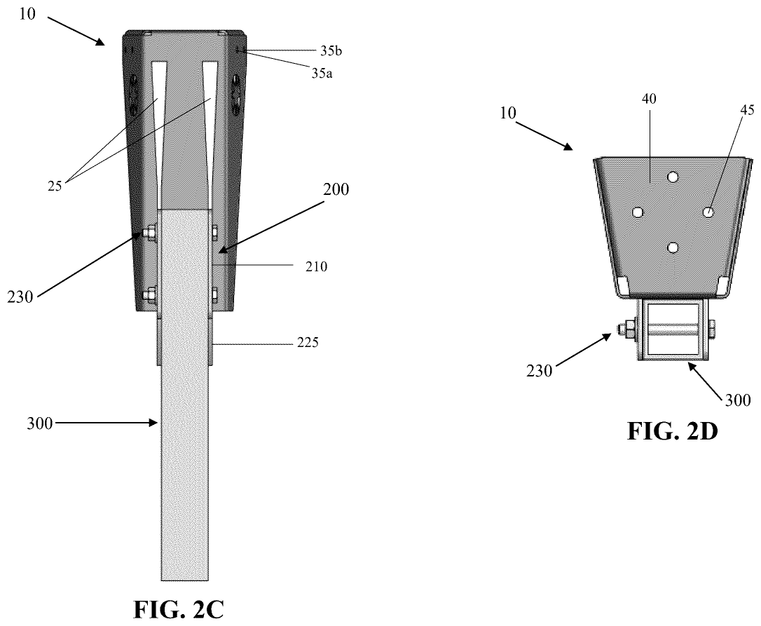

Referring to FIG. 1A, an exemplary upper support bracket 10 is shown in accordance with aspects of the present disclosure. Upper support bracket 10 may include a front face 20, side faces 30, and a top face 40. Front face 20 may define a pair of elongated apertures 25. Elongated apertures 25 may be configured for receipt and securement of a pair of hook points 225 (see, FIG. 2A). Side faces 30 may define fastener holes 35a, 35b, and top face 40 may define fastener holes 45. While shown as circular apertures, alterative shapes and/or sizes of fastener holes 35a, 35b, 45 are contemplated (e.g., rectangular, triangular).

In aspects, upper support bracket 10 may be attached to a support (e.g., a ceiling) through fastener holes 45. In another aspect, upper support bracket 10 may be secured to a support from below through fastener holes 45. In other aspects, upper support bracket 10 may be secured to an adjacent support through fastener holes 35.

FIGS. 1B-1D illustrate various perspectives of upper support bracket 10. As seen in FIG. 1B, upper support bracket 10 includes fastener hole 35a and fastener hole 35b located near the top perimeter of side face 30 of upper support bracket 10. FIG. 1C illustrates a frontal view of upper support bracket 10, and FIG. 1D illustrates a top view of upper support bracket 10.

FIG. 2A illustrates a rack receiver assembly 500 in accordance with embodiments described herein. Rack receiver assembly 500 includes upper support bracket 10, bracket hook 200, and elongated post 300. Bracket hook 200 may include side faces 210. Bracket hook 200 may be configured to secure to elongated apertures 25 of upper support bracket 10. Each side face 210 may include a hook point 225.

Each hook point 225 may be configured to interact with an elongated aperture 25 of upper support bracket 10 to secure bracket hook 200 to upper support bracket 10. Hook points 225 may be configured to slide into elongated apertures 25 of upper support bracket 10 and translated downwardly until hook points 225 are locked into place and secured within elongated apertures 25 of upper support bracket 10. Bracket hook 200 may further be configured to be secured to an elongated post 300 by bolts 230 through bolt holes defined by side faces 210 of bracket hook 200.

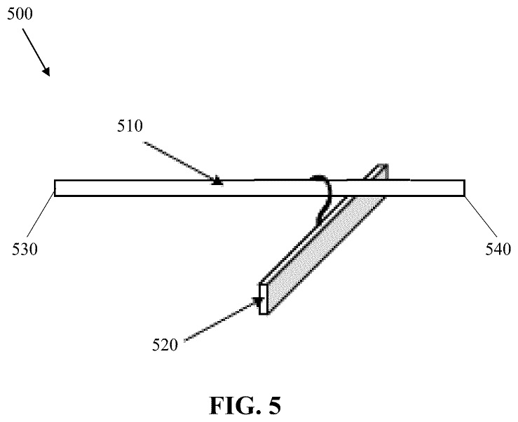

Elongated post 300 may include a side face 320. Side face 320 may define latch holes 310. Latch holes 310 may be configured to receive a connection end of a rack receiver bracket 400 (see, FIG. 5). Elongated post 300 may be configured to connect to bracket hook 200. Elongated post 300 may include a plurality of latch holes 310 within side face 320. In embodiments, elongated post 300 may be about eight feet in height and may include latch holes 310 every four inches.

Bracket hook 200 may be connected to elongated post 300 and further connected to upper support bracket 10. Bracket hook 200 may be connected to upper support bracket 10 via hook points 225 being positioned through elongated apertures 25. Elongated post 300 may extend a vertical distance between upper support bracket 10 and a ground component. Rack receiver bracket assembly may further include an elongated rack 510 and hangers 520 (see, FIG. 5).

FIGS. 2B-2D illustrate various perspectives of rack receiver assembly 500 (e.g., a rack receiver bracket assembly). FIG. 2B illustrates a profile view of rack receiver assembly 500, FIG. 2C illustrates a back view of rack receiver assembly 500, and FIG. 2D illustrates a top view of rack receiver assembly 500.

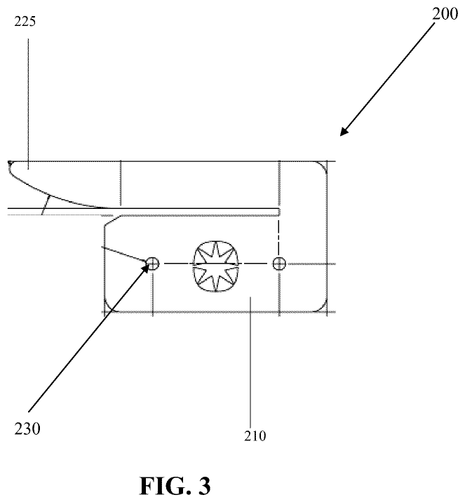

FIG. 3 illustrates a side view of bracket hook 200.

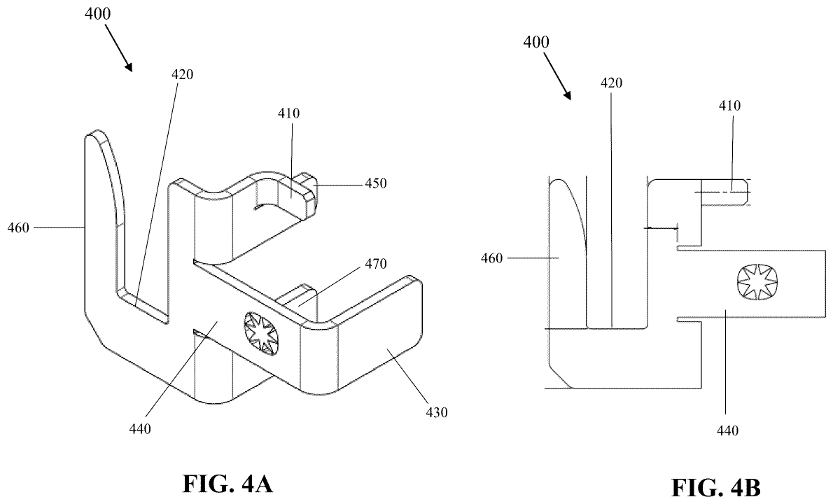

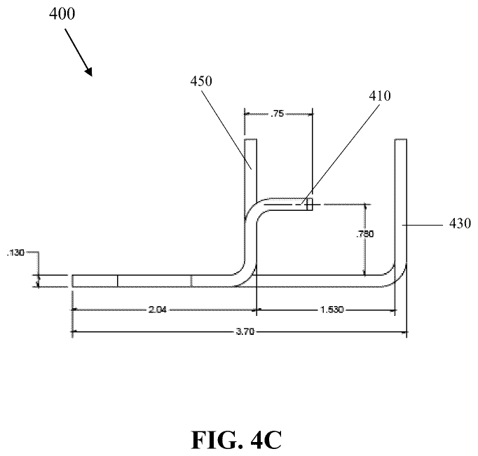

FIG. 4A illustrates an exemplary rack receiver bracket, in accordance with the present disclosure. Rack receiver bracket 400 includes a connection tab 410, rack receiving cradle 420, a hook 460, and prongs 430, 450, and 470. Connection tab 410 of rack receiver bracket 400 may be configured to interact with and to be secured within latch hole 310 of elongated post 300. Prongs 450 and prong 470 may be positioned adjacent to side face 320 of elongated post 300. Prong 430 may be parallel to prongs 450, 470 and positioned on the opposite side face 320 of elongated post 300.

FIGS. 4B and 4C illustrate various perspectives of rack receiver bracket 400. FIG. 4B illustrates a side view of rack receiver bracket 400 and FIG. 4C illustrates a top view of rack receiver bracket 400.

FIG. 5 illustrates an exemplary elongated rack 510 and hangers 520, in accordance with the present disclosure. Hangers 520 may be configured to lock in place at a point on elongated rack 510. Elongated rack 510 includes a first end 530 and a second end 540. Hangers 520 may be configured to support vegetation.

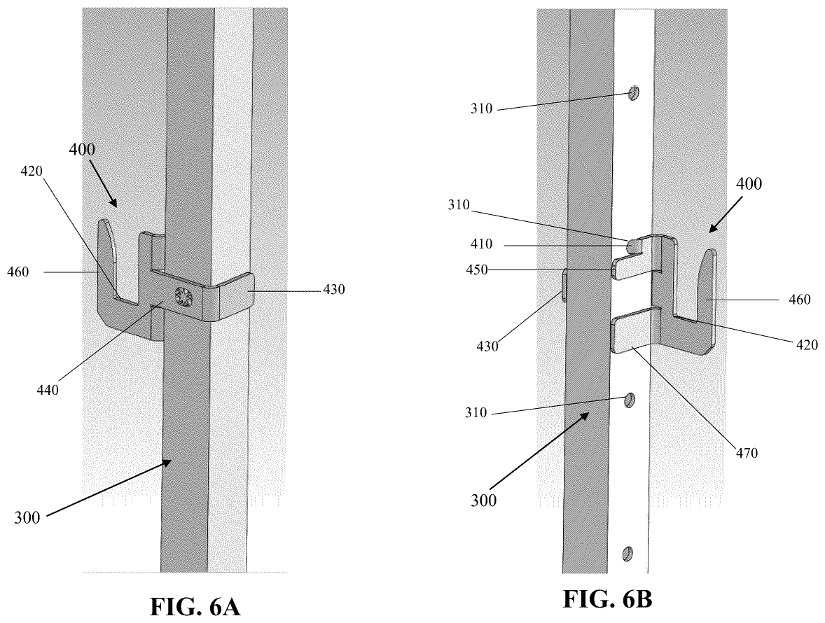

FIGS. 6A and 6B illustrate connecting rack receiver bracket 400 to elongated post 300, in accordance with the present disclosure. Connection tab 410 of rack receiver bracket 400 may be configured to interact with and to be secured within one of the latch holes 310 of elongated post 300. Rack receiving cradle 420 and hook 460 may define a rectangular opening within rack receiver bracket 400 for receiving an elongated rack 510.

Connection tab 410 of rack receiver bracket 400 may be configured to be secured in a vertical position relative to side face 320 of elongated post 300 by aligning connection tab 410 with one of latch holes 310 and with prongs 450, 470 alongside one side face 302 of elongated post 300. Connection tab 410 of rack receiver bracket 400 may be configured to be placed into latch hole 310 and rack receiver bracket 400 turned 90 degrees to lock rack receiver bracket 400 at a vertical position relative to side face 320 of elongated post 300. Elongated post 300 may extend a vertical distance between upper support bracket 10 and the ground.

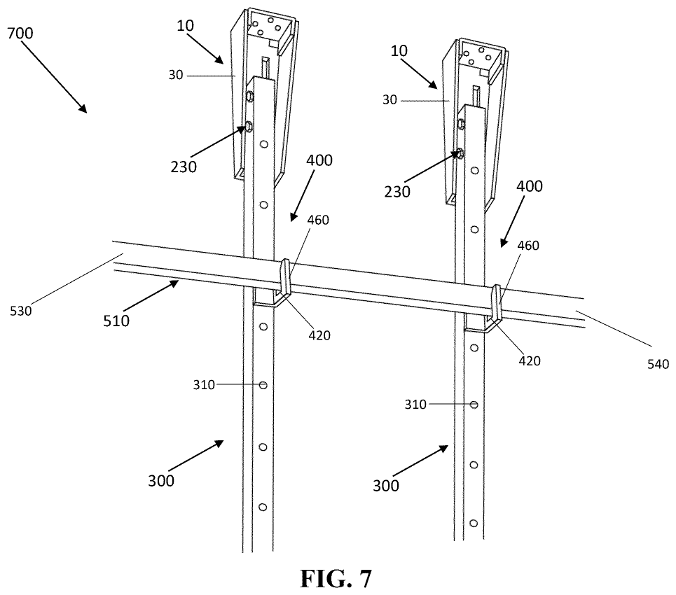

FIG. 7 illustrates an exemplary rack system 700 utilizing rack receiver bracket assemblies 500, in accordance with the present disclosure. Rack system 700 includes first and second exemplary rack receiver bracket assemblies 500, each with a rack receiver bracket 400 at a designated height. First and second rack receiver brackets 400 may be inserted into first and second latch holes 310 of first and second end of elongated post 300.

First end 530 of elongated rack 510 may rest within a first rack receiving cradle 420 of first rack receiver bracket 400 and second end 540 of elongated rack 510 may rest within the second rack receiving cradle 420 of second rack receiver bracket 400 Hangers 520 (FIG. 5) may be positioned and locked into place on elongated rack 510.

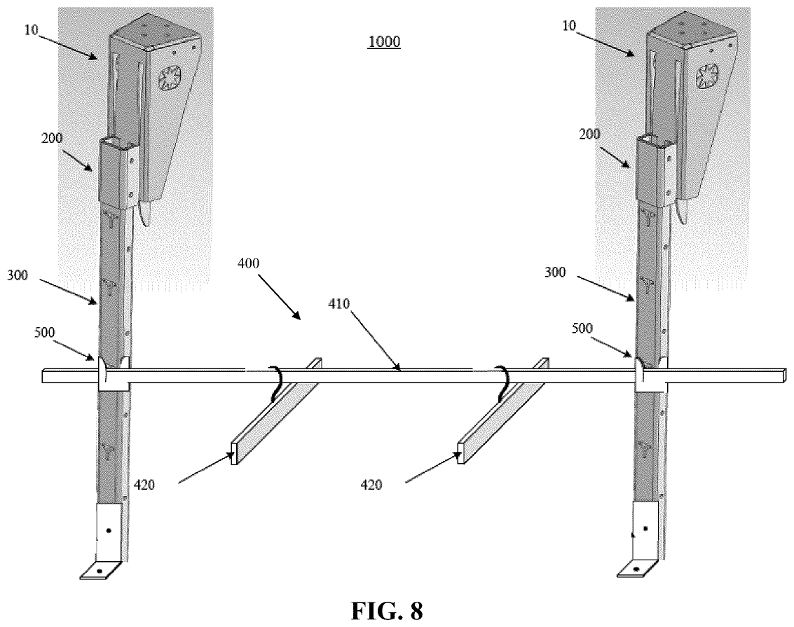

FIG. 8 illustrates an exemplary vegetation hanging system 1000, in accordance with the present disclosure. Vegetation hanging system 1000 includes the various components described herein. Generally, vegetation hanging system 1000 includes upper support bracket 10, bracket hook 200, elongated post 300, rack receiver bracket 400, and rack receiver assembly 500.

Certain aspects of the present disclosure may include some, all, or none of the above advantages and/or one or more other advantages readily apparent to those skilled in the art from the drawings, descriptions, and claims included herein. Moreover, while specific advantages have been enumerated above, the various aspects of the present disclosure may include all, some, or none of the enumerated advantages and/or other advantages not specifically enumerated above.

The aspects disclosed herein are examples of the disclosure and may be embodied in various forms. For instance, although certain aspects herein are described as separate aspects, each of the aspects herein may be combined with one or more of the other aspects herein.

Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an aspect,” “in aspects,” “in various aspects,” “in some aspects,” or “in other aspects” may each refer to one or more of the same or different example Aspects provided in the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances. The aspects described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. A rack receiver bracket assembly comprising:
an upper bracket configured to be secured to a support;
a bracket hook including a pair of hook points configured to secure the bracket hook to the upper bracket;
a rack receiver bracket including a connection tab and a rack receiver; and
an elongated post configured to support the bracket hook, the elongated post including a plurality of latch holes on a face thereof configured to receive the connection tab of the rack receiver bracket.

2. The rack receiver bracket assembly of claim 1, wherein the upper bracket further includes a pair of elongated apertures positioned on a front face of the upper bracket configured to receive the pair of hook points of the bracket hook.

3. The rack receiver bracket assembly of claim 1, wherein the upper bracket is configured to be secured to the support via a top face of the upper bracket.

4. The rack receiver bracket assembly of claim 1, wherein the upper bracket is configured to be secured to the support via a side face of the upper bracket.

5. The rack receiver bracket assembly of claim 1, wherein the rack receiver bracket defines a rectangular-shaped opening for receiving an elongated rack.

6. The rack receiver bracket assembly of claim 1, wherein the connection tab is configured to insert into a latch hole of a plurality of latch holes of the elongated post to secure the rack receiver bracket at a fixed vertical position along the elongated post.

7. The rack receiver bracket assembly of claim 1, wherein the rack receiver bracket further includes at least two prongs configured to be positioned on opposite side faces of the elongated post.

8. A system for hanging harvested vegetation, comprising:
an upper bracket configured to be secured to a support;
a bracket hook including a pair of hook points configured to secure the bracket hook to the upper bracket;
a rack receiver bracket including a connection tab, a rack receiving cradle, and first and second prongs;
an elongated post having first and second sides at least one of which includes a plurality of latch holes, wherein the connection tab of the rack receiver bracket is secured within one latch hole of the plurality of latch holes to secure the rack receiver bracket at a fixed vertical position along the elongated post with the first and second prongs positioned on the first and second sides, respectively, of the elongated post; and
an elongated rack configured to be secured within the rack receiving cradle of the rack receiver bracket.

9. The system of claim 8, wherein the upper bracket further includes a pair of elongated apertures positioned on a front face of the upper bracket, the elongated apertures configured to receive the pair of hook points of the bracket hook.

10. The system of claim 8, wherein the upper bracket is configured to be secured to the support via a top face of the upper bracket.

11. The system of claim 8, wherein the upper bracket is configured to be secured to the support via a side face of the upper bracket.

12. The system of claim 8, wherein a length of the elongated post is adjustable.

13. The system of claim 8, wherein the elongated rack is configured to support a plurality of hangers.

14. The system of claim 13, wherein a hanger of the plurality of hangers is configured to support vegetation.

15. A method for constructing a rack receiver bracket assembly, comprising:
connecting a bracket hook to an upper support bracket, wherein the bracket hook is connected to an elongated post including a plurality of latch holes on a face thereof;
adjusting the elongated post to a length spanning a distance between the upper support bracket and ground;
inserting a connection tab of a rack receiver bracket into a selected latch hole of the plurality of latch holes on the elongated post;
positioning an elongated rack on the rack receiver bracket; and
positioning a hanger on the elongated rack at a point on the elongated rack where the hanger locks in place, wherein the hanger is configured to support vegetation.

16. The method of claim 15, wherein inserting the connection tab of the rack receiver bracket includes horizontally inserting the connection tab of the rack receiver bracket into the selected latch hole on the elongated post and turning the rack receiver bracket to a vertical position to lock the rack receiver bracket into place.
